(19) United States
(12) Patent Application Publication
(10) Pub. No.: US 2004/0006848 A1
(43) Pub. Date: Jan. 15, 2004

(54) Angle adjustment device for a solar powered lamp

(76) Inventor: Ming-Sheng Hsu, Hsinchuang City (TW)

Correspondence Address: Rabin & Berdo, P.C., 1101 14th Street, Suite 500, Washington, DC, 20005, US

(21) Appl. No.: 10/193,243

(22) Filed: Jul. 12, 2002

(51) Int. Cl. E05D 3/10

(52) U.S. Cl. 16/367

(57) ABSTRACT

An angle adjustment device for a solar lamp has a seat adapted to be mounted inside the housing by a pair of first screws, a first pivot hinge pivotally connected to the seat by a first bolt-nut combination, a large sleeve rotatably mounted on top of the first pivot hinge, a small sleeve telescopically connected to and received in the large sleeve, a connector rotatably mounted on top of the small sleeve, and a second pivot hinge pivotally connected to the connector by a second bolt-nut combination.

### BACKGROUND OF THE INVENTION

1. Field of the Invention

The present invention relates to an angle adjustment device, and more particularly to an angle adjustment device for a solar powered lamp. With the angle adjustment device, the solar lamp is able to have the best angle corresponding to the available light.

2. Description of Related Art

A conventional solar lamp is shown in FIGS. 1 and 2, which has a panel (1) and a housing (2) receiving therein the panel (1) and having an extension (21) extending out from the housing (2) so that the conventional solar lamp is able to stand upright on the ground. However, this kind of solar lamp is not able to adjust its panel to cope with the change in the direction of the Sun's rays resulting from the movement of the Earth relative to the Sun.

To overcome the shortcomings, the present invention tends to provide an improved angle adjustment device to mitigate and obviate the aforementioned problems.

### SUMMARY OF THE INVENTION

The primary objective of the present invention is to provide an improved angle adjustment device so that the solar panel is able to receive maximum intensity of rays of light from the Sun.

In order to accomplish the foregoing objective, the angle adjustment device of the present invention has a seat adapted to be mounted inside a housing by a pair of first screws, a first pivot hinge pivotally connected to the seat by a first bolt-nut combination, a large sleeve rotatably mounted on top of the pivot hinge, a small sleeve telescopically connected to and received in the large sleeve, a connector rotatably mounted on top of the small sleeve and a second pivot hinge pivotally connected to the connector by a second bolt-nut combination. The solar panel is securely connected to a top face of the second pivot hinge so that the user is able to adjust the angle adjustment device of the present invention to adjust the orientation of the solar panel to allow the solar panel to always receive the maximum intensity of sunlight available.

Other objects, advantages and novel features of the invention will become more apparent from the following detailed description when taken in conjunction with the accompanying drawings.

### BRIEF DESCRIPTION OF THE DRAWINGS

FIG. 1 is a side view of a conventional solar lamp;

FIG. 2 is a perspective view of the conventional solar lamp in FIG. 1;

FIG. 3 is a schematic view showing the structure of the solar lamp of the present invention;

FIG. 4 is a schematic view showing another embodiment of the solar lamp of the present invention;

FIG. 5 is a perspective view showing the combination of the angle adjustment device of the present invention and the housing of the solar lamp;

FIG. 6 is an exploded perspective view of the angle adjustment device of the present invention;

FIG. 7 is a top plan view of FIG. 5;

FIG. 8 is a cross sectional view of FIG. 7 taken along line 8-8;

FIG. 9 is a cross sectional view of FIG. 7 taken along line 9-9; and

FIGS. 10 to 12 are side plan views showing the application of the angle adjustment device of the present invention.

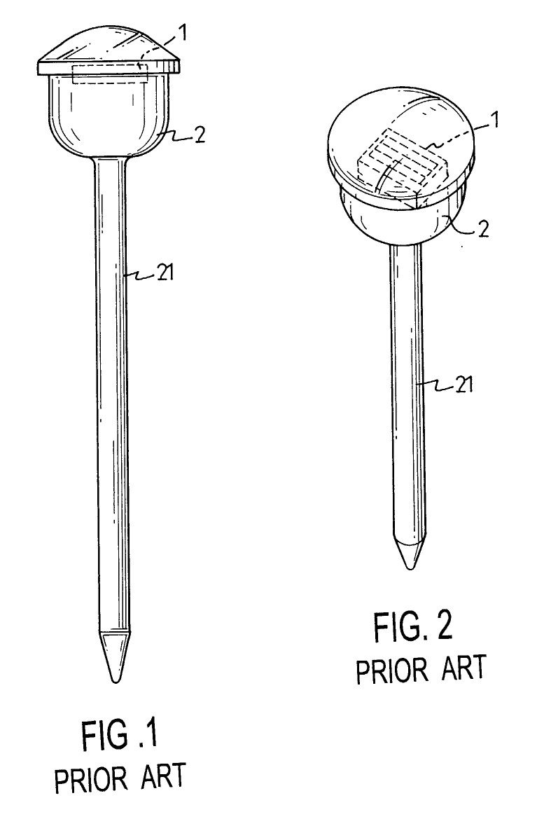

### DETAILED DESCRIPTION OF THE PREFERRED EMBODIMENT

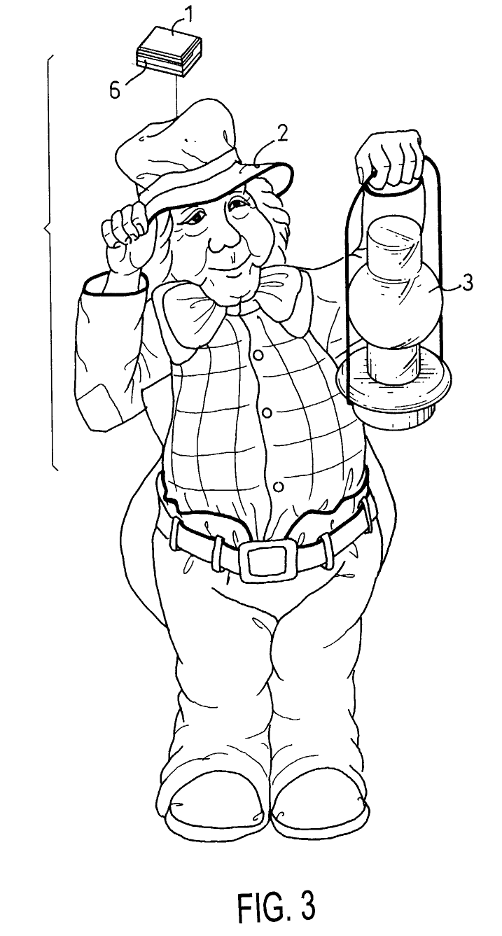

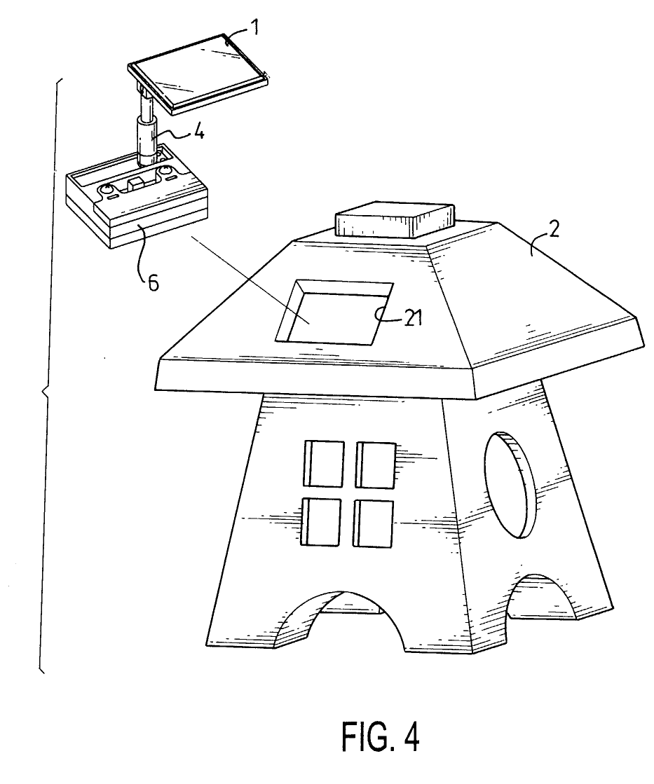

With reference to FIGS. 3 and 4, the solar lamp generally is provided with a solar panel (1) supported by an angle adjustment device (4) which is securely mounted on top of a housing (6) and the housing (6) has a battery (5) received therein, a base (2) provided with a screen (21) to receive therein the solar panel (1), the angle adjustment device (4) and the housing (6) so that the solar panel (1) is able to receive sunlight etc via the screen (21), and an illuminating element (3) which is able to illuminate when receiving electricity from the battery (5).

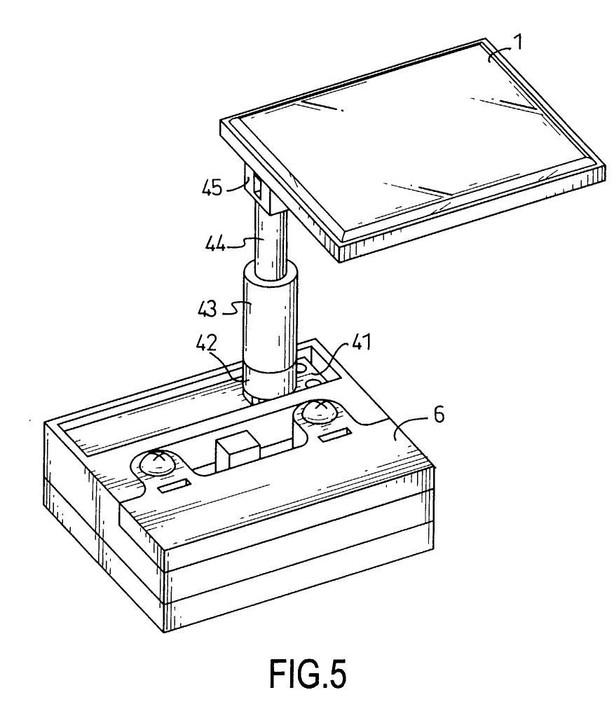

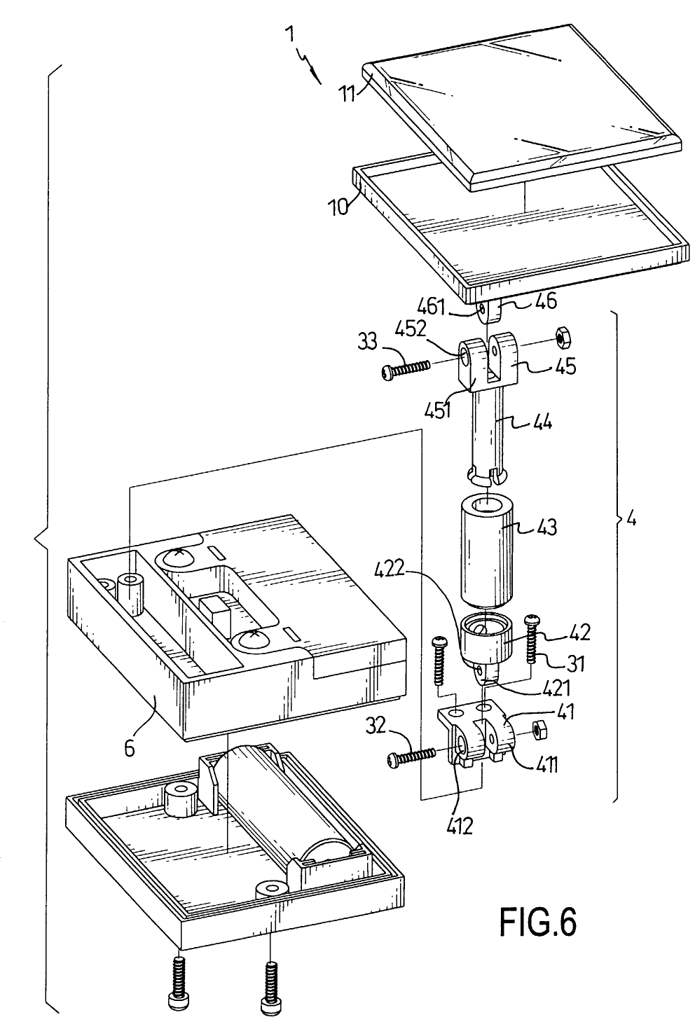

With reference to FIGS. 5 and 6, the angle adjustment device (4) of the present invention includes a seat (41) adapted to be mounted inside the housing (6) by a pair of first screws (31), a first pivot hinge (42) pivotally connected to the seat (41) by a bolt-nut combination (32), a large sleeve (43) rotatably mounted on top of the first pivot hinge (42), a small sleeve (44) telescopically connected to and received in the large sleeve (43), a connector (45) rotatably mounted on top of the small sleeve (44) and a second pivot hinge (46) pivotally connected to the connector (45) by a second bolt-nut combination (33). The second pivot hinge (46) is securely attached to a bottom side of a panel support (10) to receive therein a panel (11) of the solar panel (1).

The seat (41) has two wings (411) extending out in parallel and each wing (411) has a first hole (412) defined to align with each other. The first pivot hinge (42) has a lug (421) integrally formed on a bottom thereof and having a second hole (422) defined to align with the first holes (412).

The connector (45) has two arms (451) extending out in parallel and each arm (451) has a third hole (452) defined to align with each other. The second pivot hinge (46) has a fourth hole (461) defined to align with the third holes (452).

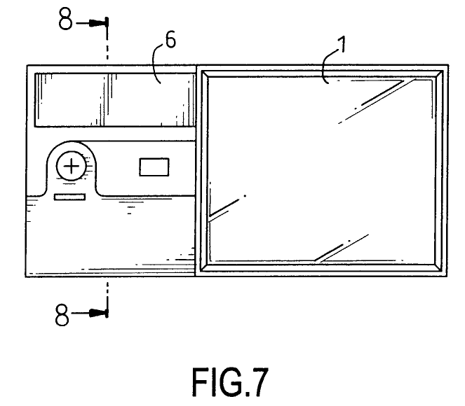

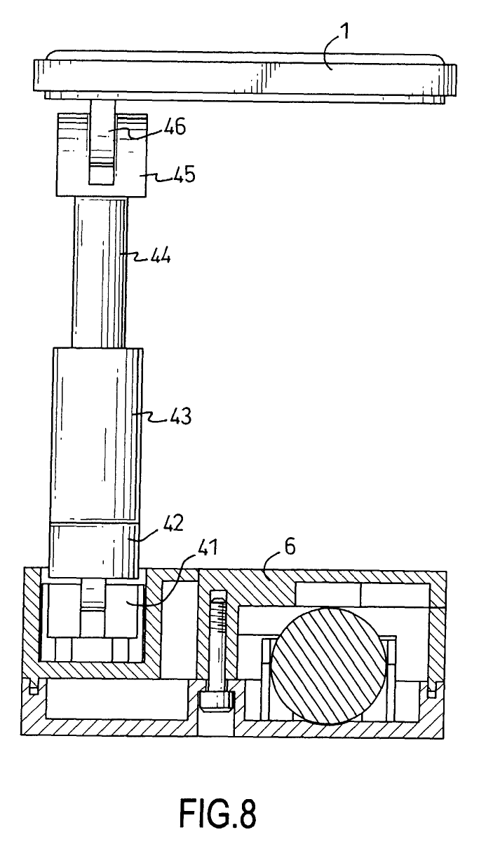

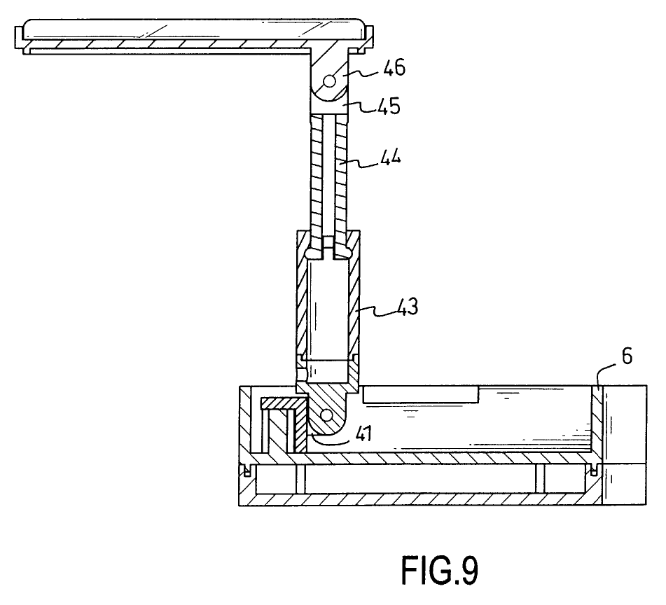

During assembly, with reference to FIGS. 7, 8 and 9, the seat (41) is first secured to the housing (6) by the first screws (31) and then the lug (421) is inserted into a gap defined between the two wings (411) to align the second hole (422) with each one of the first holes (412). Thus, the user is able to use the first bolt-nut combination (32) to fulfill a pivotal connection between the seat (41) and the first pivot hinge (42).

The second pivot hinge (46) is inserted into a gap defined between the two arms (451) and the user is able to use the second bolt-nut combination (33) to extend through the aligned third holes (452) and a fourth hole (461) in the second pivot hinge (46) to complete the pivotal requirement between the second pivot hinge (46) and the connector (45).

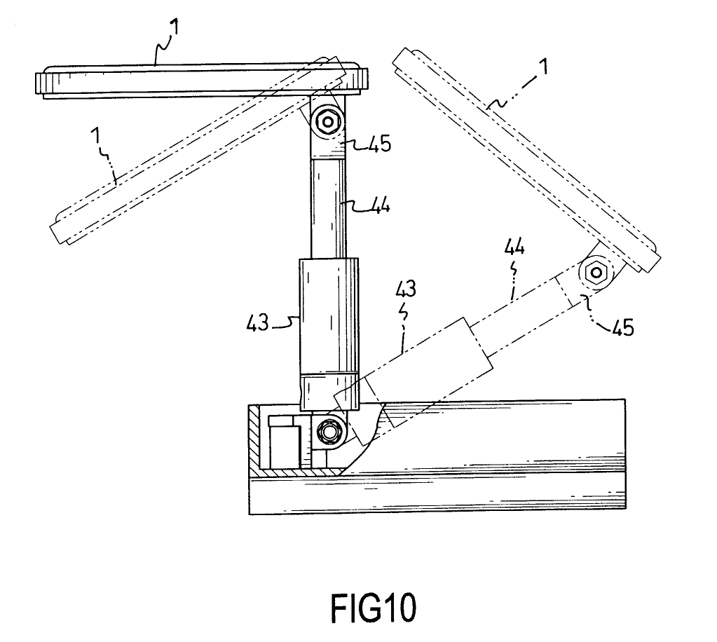

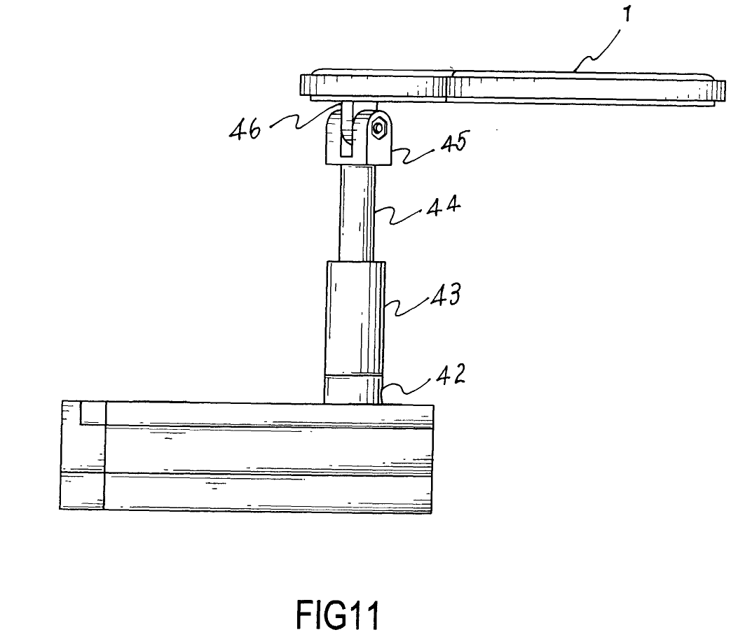

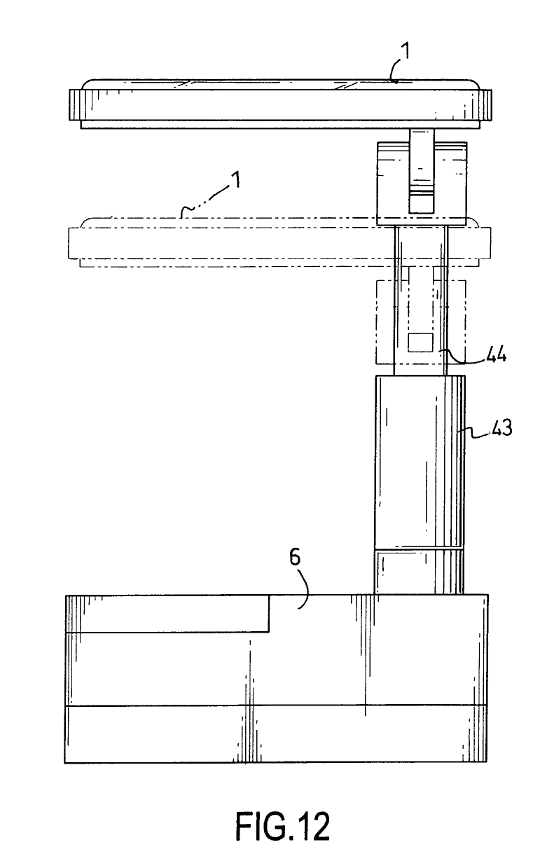

With reference to FIGS. 10 to 12, after the assembly of the angle adjustment device of the present invention, the solar panel (1) is able to pivot to the right or to the left and the small sleeve (44) is able to move upward or downward relative to the large sleeve (43) as required so that the solar panel (1) is able to cope with the change in solar beam orientation to always receive maximum intensity light.

The solar panel is securely connected to a top face of the second pivot hinge so that the user is able to adjust the angle adjustment device of the present invention to adjust the orientation of the solar panel to allow the solar panel to maximize use of available sunlight.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An angle adjustment device for a solar lamp having a solar panel supported on top of a housing, the angle adjustment device comprising:
a seat adapted to be mounted inside the housing by a pair of first screws;
a first pivot hinge pivotally connected to the seat by a first bolt-nut combination;
a large sleeve rotatably mounted on top of the first pivot hinge;
a small sleeve telescopically connected to and received in the large sleeve;
a connector rotatably mounted on top of the small sleeve; and
a second pivot hinge pivotally connected to the connector by a second bolt-nut combination.

2. The angle adjustment device as claimed in claim 1, wherein the second pivot hinge is adapted to be securely attached to a bottom side of the solar panel.

3. The angle adjustment device as claimed in claim 1, wherein the seat has two wings extending out in parallel and each wing has a first hole defined to align with each other,
the first pivot hinge has a lug integrally formed on a bottom thereof and having a second hole defined to align with the first holes so that the first bolt-nut combination is able to extend through the aligned first holes and second hole to allow the first pivot hinge to pivot relative to the seat.

4. The angle adjustment device as claimed in claim 2, wherein the seat has two wings extending out in parallel and each wing has a first hole defined to align with each other,
the first pivot hinge has a lug integrally formed on a bottom thereof and having a second hole defined to align with the first holes so that the first bolt-nut combination is able to extend through the aligned first holes and second hole to allow the first pivot hinge to pivot relative to the seat.

5. The angle adjustment device as claimed in claim 1, wherein the connector has two arms extending out in parallel and each arm has a third hole defined to align with each other,
the second pivot hinge has a fourth hole defined to align with the third holes so that the second bolt-nut combination is able to extend through the aligned third holes and the fourth hole so allow the second pivot hinge to pivot relative to the connector.

6. The angle adjustment device as claimed in claim 3, wherein the connector has two arms extending out in parallel and each arm has a third hole defined to align with each other,
the second pivot hinge has a fourth hole defined to align with the third holes so that the second bolt-nut combination is able to extend through the aligned third holes and the fourth hole so allow the second pivot hinge to pivot relative to the connector.

7. The angle adjustment device as claimed in claim 4, wherein the connector has two arms extending out in parallel and each arm has a third hole defined to align with each other,
the second pivot hinge has a fourth hole defined to align with the third holes so that the second bolt-nut combination is able to extend through the aligned third holes and the fourth hole so allow the second pivot hinge to pivot relative to the connector.
